(19) United States
(12) Patent Application Publication
(10) Pub. No.: US 2024/0219989 A1
(43) Pub. Date: Jul. 4, 2024

(54) System For Maintaining A Computer In An Active State

(71) Applicant: Steven Mueller, Brooklyn, NY (US)

(72) Inventor: Steven Mueller, Brooklyn, NY (US)

(21) Appl. No.: 18/092,293

(22) Filed: Dec. 31, 2022

(51) Int. Cl. G06F 1/3231; G06F 13/10

(52) U.S. Cl. CPC G06F 1/3231; G06F 13/102; G06F 3/03543

(57) ABSTRACT

A peripheral stimulus system for maintaining an active state computer includes a peripheral input/output device connected to the computer, a peripheral stimulus device connected to the peripheral input/output device, the peripheral stimulus device generating a stimulus received by the computer to maintain the computer in an active state.

### BACKGROUND

### Technical Field

This disclosure relates to computer accessories. In particular, but without limitation, the disclosure relates to a device for maintaining a computer operating system OS or software application in an active state.

Computer accessories to assist in power management or “sleep mode” settings are known in the art.

U.S. Pat. No. 6,539,485 discloses an intelligent sleep mode indicator.

U.S. Pat. No. 6,711,691 discloses power management for computer systems.

U.S. Pat. No. 9,229,522 discloses a system for mobile battery performance by identifying apps that disproportionately run background tasks that prevent mobile devices from sleeping.

US 2013/0212416 discloses a system for monitoring motion on a computer.

Energy saving settings on computers have proven to be a mixed blessing. While they do conserve energy, principally by shutting off the visual display, getting the computer fully operational again is time-consuming. For many users, this loss of time is more expensive than the amount of energy that is saved. For certain reasons, the user may elect to refrain from changing the energy saver settings and a device or method which defeats these settings, by simulating the presence and activity of a user sitting at the computer, would be beneficial.

Therefore, a need exists for a device for maintaining an active state of a computer OS or application software by drawing the computer's power management systems to a stimulus or action so as to stay in an active state.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### SUMMARY

A computer accessory device is disclosed that causes the screen to become active by drawing the pointer/cursor of the computer to motion or vibration keeping the system awake, active, by means of vibration as an example, but ultimately moving the pointer or drawing the pointer to active/motion by a means of vibration or anything that draws the pointer to vibrate, motion, or other stimuli causing this performance or action.

A computer accessory device to alter a power setting of a computer is disclosed. In an aspect of the disclosure, the computer accessory device includes a vibrating device for a computer mouse. The device is comprised of a rotating half-disk mounted on a shaft, with a small electric motor. When activated, the device briefly causes the half-disk to turn against the housing of the mouse, causing a vibration. This vibration defeats the power saver settings of the computer, thereby preventing the computer from becoming dormant.

In another aspect of the disclosure, a method of maintaining a computer active state includes monitoring a computer peripheral device for an action and returning the computer operating system or actively running software to an active state.

Other systems, methods, features and advantages of the disclosure will be, or will become, apparent to one with skill in the art upon examination of the following figures and detailed description. It is intended that all such additional systems, methods, features and advantages be included within this description, be within the scope of the disclosure, and be protected by the following claims.

### BRIEF DESCRIPTION OF THE DRAWINGS

The disclosure can be better understood with reference to the following drawings and description. The components in the figures are not necessarily to scale, emphasis instead being placed upon illustrating the principles of the disclosure. Moreover, in the figures, like referenced numerals designate corresponding parts throughout the different views.

FIG. 1 is an example top perspective transparency view of a mouse illustrating a device, and the mouse.

FIG. 2 is an example top perspective view of an aspect of the disclosure illustrating the device, the half-disk, the shaft and the motor.

FIG. 3 is an example front view of an aspect of the disclosure displaying the device, the half-disk and the motor.

FIG. 4 is an example top view of an aspect of the disclosure displaying the device, the half-disk, the shaft and the motor.

FIG. 5 is an example flowchart of a process to maintain a computer operating system or software application in an active state by monitoring a computer peripheral for a stimulus.

### DETAILED DESCRIPTION

The following briefly describes the aspects of the disclosure in order to provide a basic understanding of some aspects of the disclosure. This brief description is not intended as an extensive overview. It is not intended to identify key or critical elements, or to delineate or otherwise narrow the scope. Its purpose is merely to present some concepts in a simplified form as a prelude to the more detailed description that is presented later.

The elements in the Figures interoperate as explained in more detail below. Before setting forth the detail explanation, however, it is noted that all of the discussion below, regardless of the particular implementation being described, is exemplary in nature, rather than limiting. For example, although selected aspects, features, or components of the implementations are depicted as being stored in memories, all or part of systems and methods consistent with the display systems may be stored on, distributed across, or read from other machine-readable media, for example, secondary storage devices such as hard disks, floppy disks, and CD-ROMs; a signal received from a network; or other forms of ROM or RAM either currently known or later developed.

Furthermore, although specific components of the architecture will be described, methods, systems, and articles of manufacture consistent with the architecture may include additional or different components. For example, a processor may be implemented as a microprocessor, microcontroller, application specific integrated circuit (ASIC), discrete logic, or a combination of other type of circuits or logic. Similarly, memories, may be DRAM, SRAM, Flash, or any other type of memory. Flags, data, databases, tables, and other data structures may be separately stored and managed, may be incorporated into a single memory or database, may be distributed, or may be logically and physically organized in many different ways. Programs may be parts of a single program, separate programs, or distributed across several memories and processors.

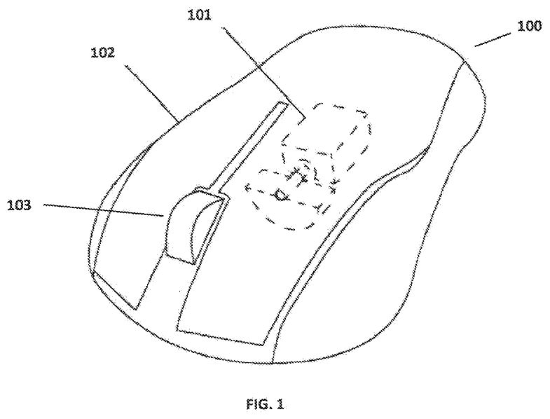

FIG. 1 is an example top perspective transparency view of a computer accessory device 100 for maintaining a computer OS or software application in an active state. The computer accessory device 100 in one aspect of the disclosure includes a peripheral stimulus device 101, and the mouse 102. The mouse 102 may contain additional functional components, such as a roller ball 103 dispositioned upon an outer top surface of the mouse 102. The roller ball 103 may be substituted with a track ball or other interface components that a user may employ on a mouse 102.

This aspect of the disclosure is intended for installation as original equipment by the manufacturer of the mouse 102. Other aspects of the vibrating device 101 intended for installation as an after-market modification by the purchaser or by a computer repair shop, are contemplated. In addition, other aspects of the disclosure may include a peripheral stimulus device 101 in the form of an oscillating body, an acoustic sensor, a speech recognition software, an accelerometer or other devices and systems that are either directly incorporated and in physical communication with the mouse 102, or may be in electromagnetic, acoustic or physical communication with the mouse 102 or a computer operated by a user with various I/O devices, such as a mouse or other input device, such as a stylus, drawing pad, augmented or virtual reality devices, motion capture and detection devices or other components or software applications that, upon receiving or sensing signals, sounds or other tangible stimuli, will draw the computer OS or software application to an active state.

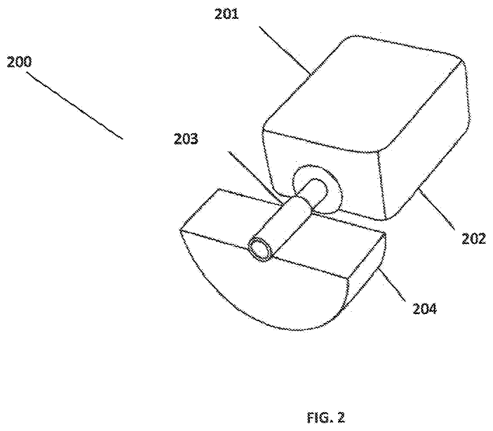

FIG. 2 illustrates an aspect of the disclosure of a peripheral stimulus system 200. The peripheral stimulus device 200 may be installed within the interior of a computer mouse 102, as illustrated in FIG. 1. In an aspect of the disclosure, the peripheral stimulus device 201 is comprised of a rotating half-disk 202 mounted on a shaft 203, with an electric motor 204 and a timer disposed within or otherwise operatively connected with the electric motor 204. The timer may be set to activate at a particular time of day or periodically, as desired by the user. When activated, the peripheral stimulus device 201 briefly causes the rotating half-disk 202 to turn against a housing of the computer mouse 102, causing a vibration. This stimulus stimulates the pointer/cursor of the computer OS or an active software application to maintain the computer OS or software application in an active state. Thus, the user is saved the time and effort of trying to reactivate the computer from a dormant state.

As related herein, other aspects of the disclosure may include a peripheral stimulus device 201 in the form of an oscillating body, an acoustic sensor, a speech recognition software, an accelerometer or other devices and systems that are either directly incorporated and in physical communication with the mouse 102 or other I/O device, or may be in electromagnetic, acoustic or physical communication with the mouse 102 or a computer operated by a user with various I/O devices, such as a mouse or other input device, such as a stylus, drawing pad, augmented or virtual reality devices, motion capture and detection devices or other components or software applications that, upon receiving or sensing signals, sounds or other tangible stimuli, will draw the computer OS or software application to an active state.

The peripheral stimulus device 201 may draw power from the mouse 102 or from a Universal Serial Bus (USB) device, and is directly connected to the wiring of the mouse 102. In other aspects of the disclosure, the peripheral stimulus device 201 may be powered by a battery and may be affixed temporarily or permanently to the exterior surface of the mouse 102. The peripheral stimulus device 201 may be always activated when the mouse 102 or other I/O device is activated, or it may be activated separately, such that when the peripheral stimulus device 201 is deactivated, the energy saver settings of the computer are allowed to function normally.

In an aspect of the disclosure, to use the disclosed aspect illustrated in FIG. 2, the user may simply step away from the computer or release, put down or otherwise cease continuous usage of the peripheral I/O device. This allows the peripheral stimulus device 201 to function periodically to maintain the computer OS or software application in an active state.

In an aspect of the disclosure, the half-disk 202, the shaft 203, and the motor 204 are preferably manufactured from rigid, durable materials which are corrosion resistant, such as stainless steel, brass, plastic, copper alloy, and aluminum alloy. The components, component sizes, and materials listed above are preferable, but a person of ordinary skill in the art will recognize that alternate components and materials could be selected without altering the scope of the disclosure.

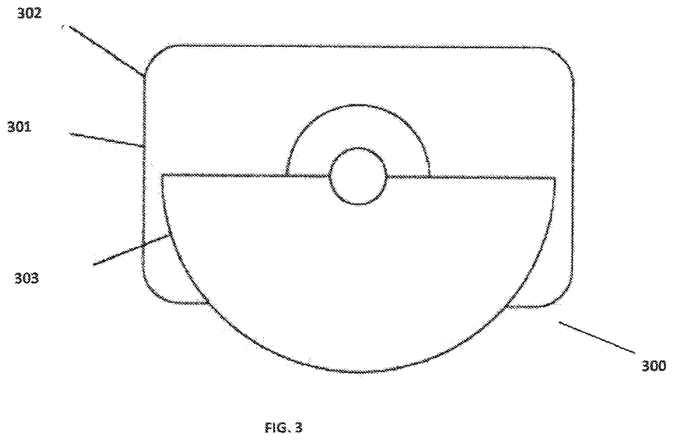

FIG. 3 is an example front view of an aspect of the peripheral stimulus system 300 displaying the peripheral stimulus device 301, the half-disk 302, and the motor 303. To use the disclosed aspect illustrated in FIG. 3, the user may simply step away from the computer or release, put down or otherwise cease continuous usage of the peripheral I/O device. This allows the peripheral stimulus device 301 to function periodically to maintain the computer OS or software application in an active state.

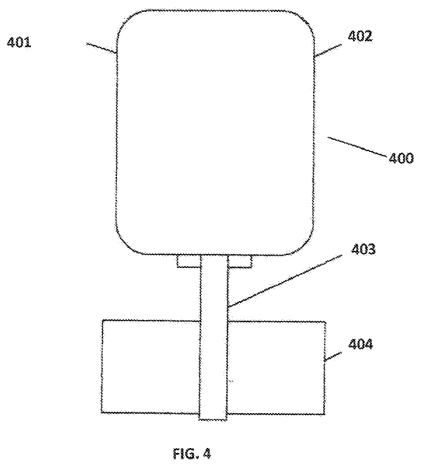

FIG. 4 an example top view of an aspect of a peripheral stimulus system 400. The peripheral stimulus system 400 includes a peripheral stimulus device 401, the half-disk 402, the shaft 403 and the motor 404. To use the disclosed aspect illustrated in FIG. 4, the user may simply step away from the computer or release, put down or otherwise cease continuous usage of the peripheral I/O device. This allows the peripheral stimulus device 301 to function periodically to maintain the computer OS or software application in an active state.

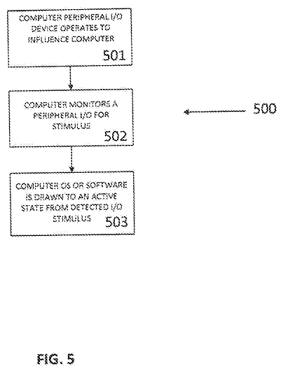

FIG. 5 is an example flowchart 500 of a process to maintain a computer OS or software application in an active state by monitoring a computer peripheral for a stimulus. In act 501, a computer peripheral I/O device, such as a mouse or other input device, such as a stylus, drawing pad, augmented or virtual reality devices, motion capture and detection devices or other components or software applications is operated in a normal, non-dormant state to influence the computer OS or software application via a cursor, pointer or other indication of interaction with the computer OS or software application currently running.

In act 502, the computer being operated will monitor the peripheral I/O devices in communication with the computer for signals or stimuli indicating activation, energizing or other operation of the peripheral device. The computer may monitor the peripheral I/O devices on a periodic interval, a random interval or at times pre-defined by the computer OS, a software application or other component involved in power management or computer state change control.

In act 503, upon receiving or sensing signals, sounds or other tangible stimuli from a peripheral I/O device, the computer will draw the computer OS or software application to an active state. In an aspect, a vibration, sound, electromagnetic, optical, haptic, motion detection or motion capture or other physical, electromagnetic or aural stimulus from a peripheral stimulus device may serve to influence a cursor, pointer or other I/O interface indicator on the computer to draw the computer OS or software application to an active state. In an aspect, the active state of the computer is maintained by altering a power setting of the computer.

While various aspects of the disclosure have been described, it will be apparent to those of ordinary skill in the art that many more aspects and implementations are possible within the scope of the disclosure. Accordingly, the disclosure is not to be restricted except in light of the attached claims and their equivalents.

What is claimed is:

1. A peripheral stimulus system for maintaining an active state on a computer, comprising:
a input/output device in communication with the computer, the input device configured to accept input regarding operations of the computer;
a peripheral stimulus device operatively connected to the input device, the peripheral stimulus device comprising:
a rotating member;
a motor; and
a shaft connecting the rotating member to the motor;
the peripheral stimulus device operable to cause a vibration against a surface of the input device to maintain the active state of the computer.

2. The peripheral stimulus system of claim 1, where the peripheral stimulus device further comprises a timer operatively connected to the motor.

3. The peripheral stimulus system of claim 1, where the input/output device comprises a mouse or a trackball mechanism.

4. The peripheral stimulus system of claim 1, where the peripheral stimulus device is disposed internally within the input/output device.

5. The peripheral stimulus system of claim 1, where the peripheral stimulus device is disposed externally and in mechanical communication with the input/output device.

6. The peripheral stimulus system of claim 1, where the input/output device is wirelessly in communication with the computer.

7. The peripheral stimulus system of claim 1, where the input/output device is in communication with the computer via a wired interface.

8. The peripheral stimulus system of claim 2, where the timer is operable to be set for periodic time periods to activate the peripheral stimulus device.

9. The peripheral stimulus system of claim 2, where the timer is operable to be set for random time periods to activate the peripheral stimulus device.

10. The peripheral stimulus system of claim 1, where the rotating member comprises a rotating half-disk.

11. The peripheral stimulus system of claim 1, where the motor comprises a battery operable to power the motor.

12. The peripheral stimulus system of claim 1, where the motor is in communication with a USB power source operable to power the motor.

13. The peripheral stimulus system of claim 1, where at least one of the motor, shaft and rotating member is composed of stainless steel, brass, plastic, copper alloy or aluminum alloy.

14. A peripheral stimulus apparatus to maintain an active state of a computer, comprising:
a peripheral input/output device in communication with the computer; and
a peripheral stimulus device operatively connected to the peripheral input/output, where the peripheral stimulus device is configured to generate a stimulus received by the computer so as to maintain the computer in the active state.

15. The peripheral stimulus apparatus of claim 14, where the peripheral stimulus device comprises a vibrating device, an optical signal stimulus device, an electromagnetic signal stimulus generating device, a motion detection/capture device or a combination thereof.

16. A method of maintaining a computer in an active state, the method comprising:
detecting a connection between a peripheral input/output device, the peripheral input/output device comprising a peripheral stimulus device in communication with the peripheral input/output device;
monitoring, by the computer, input of the peripheral input/output device;
upon receiving a stimulus from the peripheral stimulus device, maintaining the active state of the computer.

17. The method of claim 16, where the peripheral stimulus device comprises a vibrating device, an optical signal stimulus device, an electromagnetic signal stimulus generating device, a motion detection/capture device or a combination thereof.

18. The method of claim 16, where the peripheral stimulus device comprises a timer in communication with the peripheral stimulus device.

19. The method of claim 16, where the peripheral input/output device comprises a mouse, a stylus, a drawing tablet, a augmented or virtual reality devices, motion capture/detection devices or a combination thereof.

20. The method of claim 16, where maintaining the active state of the computer comprises altering a power setting of the computer.
